(19) United States
(12) Patent Application Publication
(10) Pub. No.: US 2002/0176951 A1
(43) Pub. Date: Nov. 28, 2002

(54) Load distribution mechanism and method for towers

(76) Inventors: Khaled M. Al-Zoubi, Raleigh, NC (US); Ibrahim Hathout, Mississauga (CA)

Correspondence Address: JINAN GLASGOW, P O BOX 28539, RALEIGH, NC, 276118539

(21) Appl. No.: 10/202,917

(22) Filed: Jul. 25, 2002

Related U.S. Application Data
(63) Continuation-in-part of application No. 09/858,402, filed on May 16, 2001.

(51) Int. Cl. F16L 1/00; B65D 1/00

(52) U.S. Cl. 428/34.1

(57) ABSTRACT

A load redistribution mechanism for monopoles that facilitates installation, adjusts to area and space requirements, directs load forces along a substantially perpendicular vector to the monopole, and redistributes sum load of forces on the monopole is described. The invention is composed of a variable number of legs that are attached to the monopole at one end and attached to a base at the other end. The legs, generally segmented, allow the transfer of the load along a vector substantially perpendicular to the monopole, are spaced equally at equal angles, and extend equidistantly from the center of the monopole to their respective bases to support the monopole. The method for constructing and installing the invention is also described.

### CROSS-REFERENCE TO RELATED APPLICATIONS

This nonprovisional utility patent application claims the benefit of one or more prior filed co-pending nonprovisional applications; a reference to each such prior application is identified as the relationship of the applications and application number (series code/serial number): The present application is a Continuation-In-Part of application Ser. No. 09/858,402, incorporated herein by reference in its entirety.

### BACKGROUND OF THE INVENTION

(1) Field of the Invention

The present invention relates generally to structural support of towers and, more particularly, to a load distribution mechanism and method for structural support of monopoles.

(2) Description of the Prior Art

Monopoles are widely employed as supports for antennae and other devices for wireless communication. They are also used to support conductors in power transmission. Increased wireless communication has increased demand for monopole capacity. Although many new monopoles are being installed, existing monopoles are also being used to elevate and support new and old antennae and other wireless communication devices. However, the existing monopoles are often used beyond their rated capacity. These monopoles are therefore prone to fail, resulting in damage to the monopole and supported equipment and loss of service to the users. To support their new loads monopoles are increasingly being retrofitted by additional reinforcement.

Self-support monopoles are tapered or stepped. Stepped monopoles are formed by joining together monopoles of various diameters. Diameter and wall-thickness increases as the distance from the apex increases to reduce the overall weight and expense of the monopole and allow the self-supporting monopoles to act as cantilevers when the loads travel to the ground in a bending mode. The maximum moment is always at ground level. Therefore, the moment and strength of the monopole decrease towards the apex. Further, monopoles are flexible structures that can undergo large deflection, at the apex, of up to 10% of their height under maximum loads. Since monopoles normally support appurtenances near the apex, the bending moment at any location along the height is the vector sum of primary moment and secondary moment. The primary moment at a specific location is due to wind load on the projected areas of the appurtenances, pole, platforms, etc. while the secondary moment is due to all weights above that location as they deflect from the vertical position. The secondary moment is usually very significant for tall monopoles due to the large top deflection. Since the moment increases as the distance from the apex increases, any additional appurtenances or devices, such as antennas, microwave dishes, mounting platforms or brackets, transmission lines, lights, reflectors, signs, flags, and the like not accounted for in the design of the structure may cause structural failures. Because the function of the monopole is to elevate appurtenances above the ground, and therefore the majority of the appurtenances are attached at or near the apex of the monopole, these present a greater projected area at or near the apex of the monopole and thereby increasing the bending stress or inertial moment in the area of least strength of the monopole. These devices may add approximately between 500 to 4000 lbs weight to the monopole. This weight is not excessive under low wind conditions because the weight is supported axially through the centerline of the monopole. However, under higher wind conditions, these appurtenances add to the secondary moment of the monopole. Therefore, as wind speed increases, the bending stress increases in a disproportionately greater manner due to the addition of the weight of the appurtenances to the bending stress of the monopole.

Monopoles were originally designed to house wave-guides or coaxial cables internally, allowing them to exit through portholes at the apex of the monopole in proximity of the antennas. However, monopoles so designed are now being employed to support a number of wave-guides beyond their internal capacity. These wave-guides must therefore be attached externally to the monopole and thus require an external support. Additionally, these external wave-guides increase the projected area of the monopole. Due to the forces described above (weather conditions, added load from appurtenances) monopoles often require reinforcement from apex to base. Solutions to support or reinforce monopoles in order to support these forces have been proposed.

Some prior art devices extend for a considerable length along the monopole, but apply the bracing force to small areas of the monopole and to the devices themselves. These devices subject the monopole and themselves to increased forces in small, focused area, thus increasing the wear and fatigue of both the monopole and device in these areas. Such devices include splints, various types of sleeves, and other braces. When reinforcing devices are added to the monopole the foundation experiences further stress due to the added load and resulting monopole reactions. Thus there exists a need to redistribute the sum load to support the foundation and thus, the entire monopole.

In the prior art, reinforcements have been designed to stabilize and support the entire monopole relative to the ground. U.S. Pat. No. 6,343,445 to Ray R. Ryan describes an invention directed to a tower structure for supporting communications equipment or other types of equipment above the ground. The structure includes a foundation, a tower supported by the foundation that has a number of tower sections, and a cable support structure connected to the tower and anchored to the ground.

While such devices as cable support systems serve the purpose of redistributing load they require a large area at the base of the monopole. As such they are unsuitable when area or space around the tower structure is legally or practically limited. Moreover, when area or space is not a limiting factor, such support structures tend to extend and overreach creating an aesthetic and physical nuisance. Thus, these support structures are not suitable alternatives for monopoles which are increasingly being installed or are already installed in highly visible and/or space-restricted areas. Cable support structures also only provide support when under tension, not when under compression. Therefore, individual cables in cable support structures do not provide full-time support, that is, load support when the monopole is deflecting away from the support and when it is deflecting toward the support. Additionally, cable support structures require an anchor in the ground surrounding the monopole. These anchors, generally made of concrete poured on-site, require considerable labor to install. Furthermore, because cable systems work only under tension, the anchoring force is the sum of the weight of the anchor and the resistance of the surrounding ground.

Moreover, installation of support structures such as a cable support structure is difficult and time-consuming because they are installed at high elevations. As such installation requires highly skilled technicians and expense increases.

Simple, rigid, linear supports that connect an anchor with the monopole have also been installed to support tall structures by reducing the base moment. When properly installed, these structures do provide support when under compression and when under tension. These structures are most effective at reducing the base moment when the support angle between the support and the monopole approach 90 degrees. However, as the support angle approaches the normal, the linear support must extend a greater distance to reach the ground. This configuration can be impractical, as it requires a larger area around the base of the monopole.

Thus, there remains a need for a load redistribution reinforcing system for monopoles that facilitates installation, maximizes the base moment-resisting force for a given area and space, and redistributes sum load of forces on the monopole. The invention to be described here addresses these needs.

### SUMMARY OF THE INVENTION

The present invention is directed to a load redistribution device for installation of and attachment to a monopole. Also, the present invention is directed to a method for achieving load redistribution for monopoles using a load redistribution device that is attached to a monopole proximal to its base.

Thus, it is one aspect of the present invention to provide a load redistribution device for monopoles including a plurality of legs, each leg having an upper and lower end and at least one joint, the upper end attachably joined at a load-bearing height to a monopole and the lower end attachably joined to a base or to the ground substantially perpendicular to the ground at a predetermined, variable radial distance from a center of the monopole and at various positions surrounding the monopole.

It is another aspect of the present invention to provide a method for providing load redistribution for a monopole including the steps of: calculating the initial load on the monopole; calculating load redistribution for the monopole including a plurality of jointed legs attached to the monopole at predetermined locations and connecting or securing the legs in a foundation or on the ground base surrounding the monopole at predetermined radial distances and positions located on a concentric line about the monopole; and attaching the legs to the monopole and ground at those predetermined locations.

These and other aspects of the present invention will become apparent to those skilled in the art after a reading of the following description of the preferred embodiment when considered with the drawings.

### BRIEF DESCRIPTION OF THE DRAWINGS

FIG. 1 is a side view of the one-segment version of a preferred embodiment of the load redistribution mechanism according to the present invention.

FIG. 2 is a side view of the two-segment version of a preferred embodiment of the load redistribution mechanism according to the present invention.

FIG. 3 is a side view of the three-segment version of a preferred embodiment of the load redistribution mechanism according to the present invention.

FIG. 4 is a detailed and enlarged side view of the one-segment version of a preferred embodiment of the load redistribution mechanism according to the present invention.

FIG. 5 is a detailed and enlarged side view of the three-segment version of a preferred embodiment of the load redistribution mechanism according to the present invention.

FIG. 6 is a cross sectional view from above of the three three-segment-leg legged version of a preferred embodiment of the load redistribution mechanism according to the present invention.

FIG. 7 is a top view of one example of a design for support of a load redistribution mechanism according to the present invention.

FIG. 8 is a perspective view of one example of the three-legged, three-segment version of a preferred embodiment of the load redistribution mechanism according to the present invention.

FIG. 9 is a perspective view of one example of the four-legged, one-segment version of a preferred embodiment of the load redistribution mechanism according to the present invention.

FIG. 10 is a perspective view of a base with attached leg.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

Referring now to the drawings in general, the illustrations are for the purpose of describing a preferred embodiment of the invention and are not intended to limit the invention thereto.

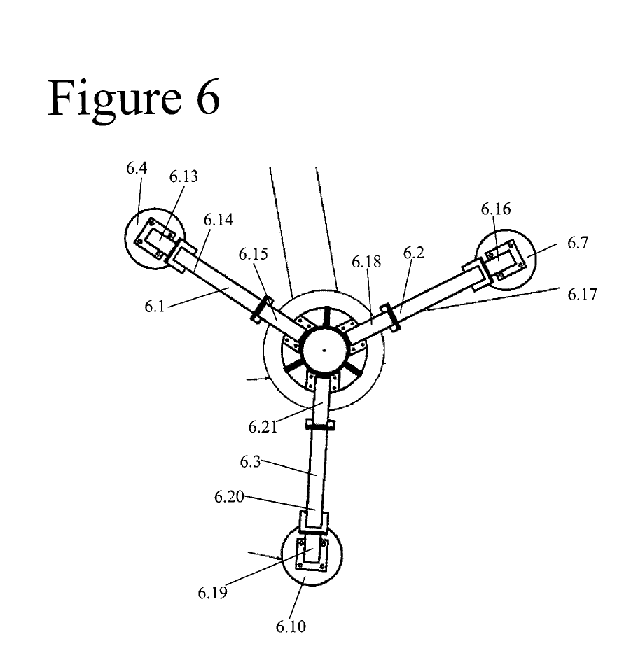

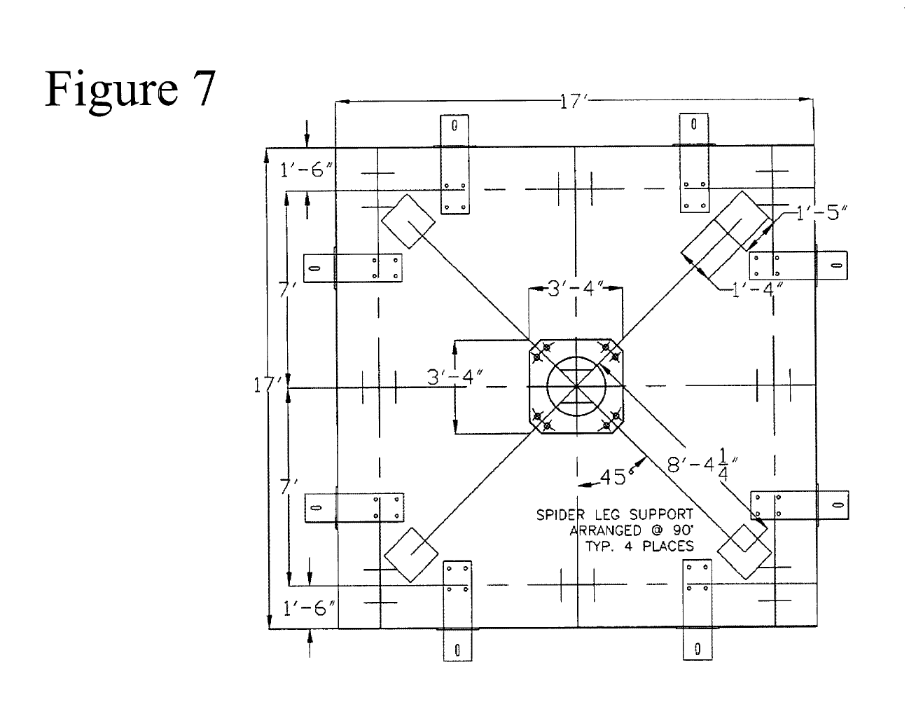

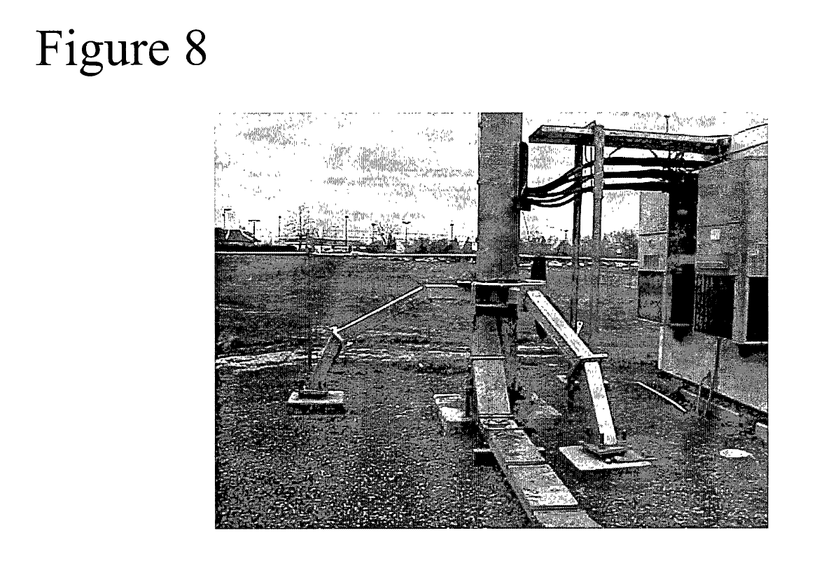

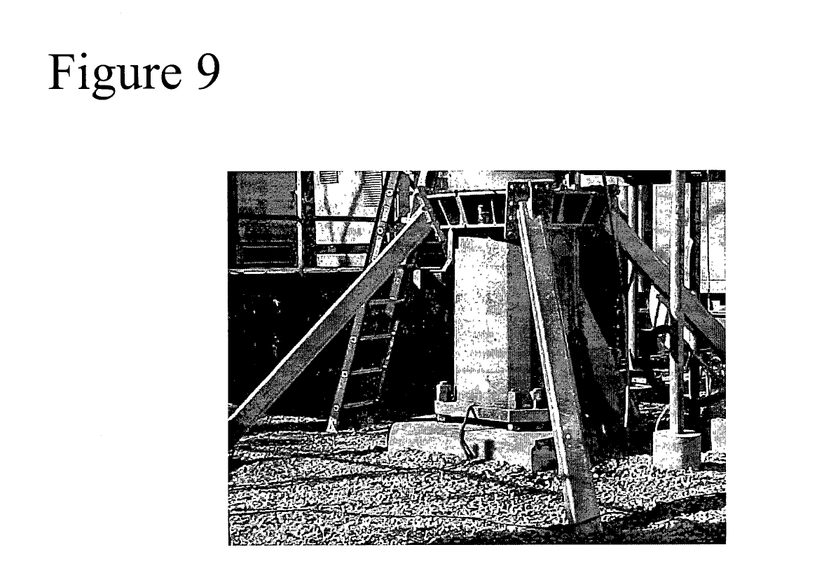

Legs redistribute the load experienced by the monopole. The attachment of a leg to the monopole surface, either original or reinforced surface, is able to transfer loads and moments to the leg. As shown in FIG. 6, FIG. 7, and FIG. 8, a load redistribution mechanism generally has two or more legs. In the preferred embodiment, as shown in FIG. 6 and FIG. 8, a load redistribution mechanism has three or more legs. Preferably the legs are of equal size and length. Preferably, the legs are spaced apart from each other. In a preferred embodiment three legs are equally spaced apart forming 120-degree angles. FIG. 6 is a cross sectional view from above of a three-legged version of a preferred embodiment of the load redistribution mechanism. As shown in FIG. 9, in a preferred embodiment four legs are equally spaced apart forming 90-degree angles. FIG. 7 shows a cross sectional view from above a four-legged version of a preferred embodiment of the load redistribution mechanism. In another preferred embodiment five legs are equally spaced apart forming 72-degree angles. In even another preferred embodiment six legs are equally spaced apart forming 60-degree angles. Preferably legs of a load redistribution mechanism are spaced apart from each other at equal angles.

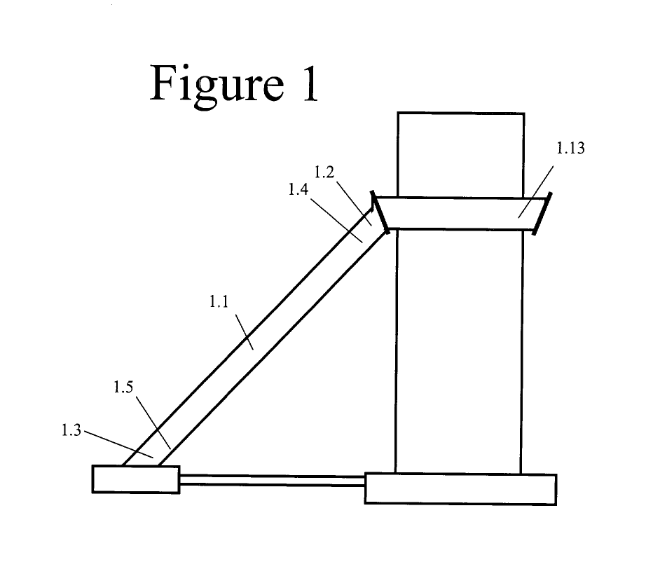

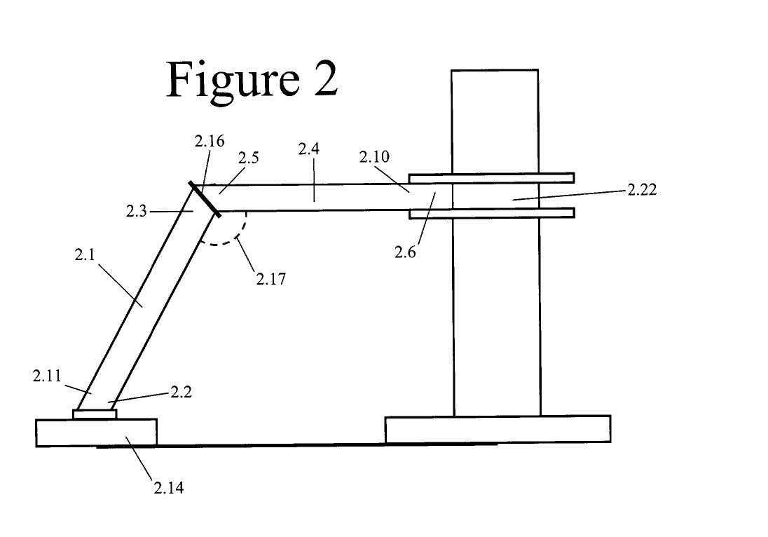

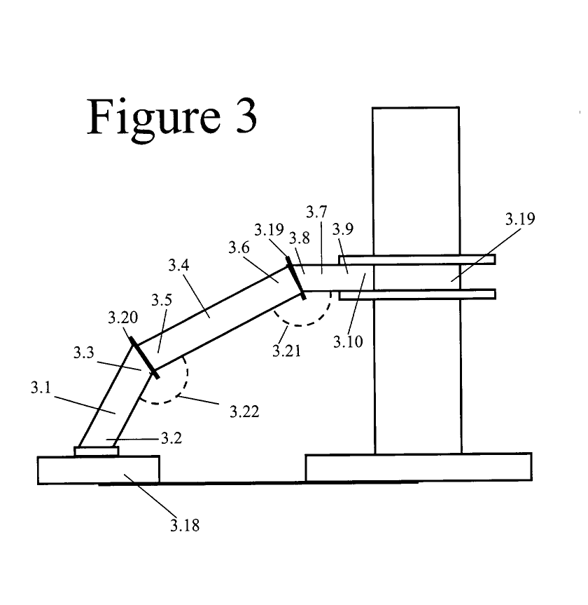

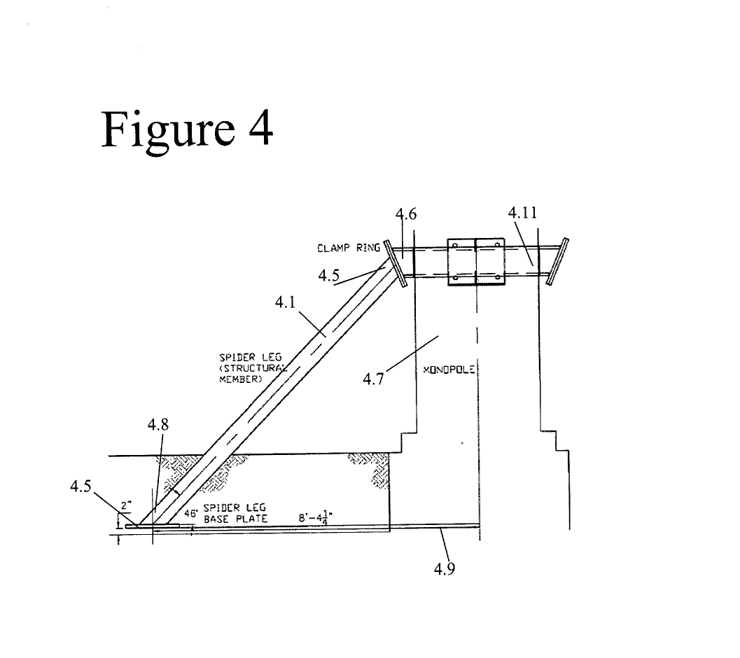

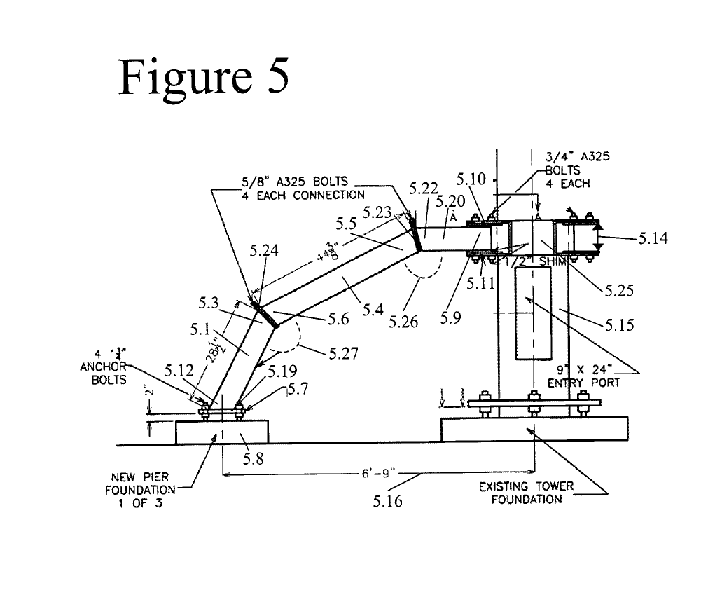

Legs generally have upper and lower ends. As shown in FIG. 1, 1.4, FIG. 2, 2.10, FIG. 3, 3.10, FIG. 4, 4.5, FIG. 5, 5.9, each leg generally has an upper end. The upper end of a leg is attachable at a variable load-bearing elevation to the monopole. Preferably, the upper end of each leg is substantially normal to the long axis of the monopole, in order to maximize the force opposing the monopole moment and distribute more of the moment onto the leg. Also preferably the upper end of each leg is attached to the monopole at the same height. As shown in FIG. 1, 1.13, FIG. 2, 2.19, FIG. 3, 3.22, FIG. 4, 4.11, FIG. 5, 5.25, the height at which the upper end of a leg will be joined to the monopole will be determined according to conditions including the area restrictions, the circumstances, condition or state of the monopole, and the load to be redistributed. The upper end may include a monopole attachment device. As shown in FIG. 4, preferably, the upper end is attachable to a clamp ring 4.6 which in turn is connected or welded to the monopole 4.7. Alternatively, as showing in FIG. 5, preferably, the upper end is attachably joined to a monopole at height 5.25. The upper end of the leg 5.9 attaches to upper face plate, 5.10, and lower face plates, 5.11. Upper faceplate and lower faceplate are fixed to monopole 5.15 at length 5.14 from each other such as to fit upper end of leg 5.9. The faceplates and the upper end may have holes positioned such that bolts or screws or other fasteners may pass through to join the upper end of the leg to the monopole.

As shown in FIG. 1, 1.5, FIG. 2, 2.7, FIG. 3, 3.11, FIG. 4, 4.8, FIG. 5, 5.12, each leg generally has a lower end as well. The lower end of a leg may have a base attachment device. Alternatively preferred, the lower end may be attachable to the base plate of the base. Even more alternatively preferred, as shown in FIG. 4, 4.5, the lower end may have a base plate welded to it such that the base plate lies flat against a foundation 5.11 and is connected to the foundation. Even more alternatively preferred the lower end of a leg is a base plate such that the base plate lies flat against a foundation and is attached to the foundation. Preferably, as shown in FIG. 4, and FIG. 5, the lower end of a leg is attachable to a base at a variable radial distance from the center of the monopole, 4.8 and 5.16, respectively.

Each leg is composed of a plurality of segments. Here, a plurality of segments also includes one segment. As shown in FIG. 1 and FIG. 4, a leg may be made of one segment, as seen by 1.1 and 4.1, respectively. As shown in FIG. 2, a leg may be composed of two segments, 2.1 and 2.4. As shown in FIG. 3 and FIG. 5, a leg may be composed of three segments, 3.1, 3.4, and 3.7, and 5.1, 5.4, and 5.20 respectively. The segments are composed of structural tubing, steel rods or any other rigid, load-bearing structure, and as such can provide support when under compression and when under tension. The segments may be made of any materials normally used to provide structural support, including, but not limited to, metals, plastics, composites, and the like.

As shown in FIG. 6, in a preferred embodiment each leg of a load redistribution mechanism has an equal number of segments, legs 6.1, 6.2, 6.3 each have three segments, 6.13, 6.14, 6.15, and 6.16, 6.17, 6.18, and 6.19, 6.20, 6.21, respectively. Each segment of a leg has a first and second end. As shown in FIG. 1, segment 1.1 has first end 1.3 and second end 1.2. As shown in FIG. 2, segment 2.1 has first end 2.3 and second end 2.2; segment 2.4 has first end 2.6 and second end 2.5. As shown in FIG. 3, segment 3.1 has first end 3.3 and second end 3.2, segment 3.4 has first end 3.6 and second end 3.5, and segment 3.7 has first end 3.9 and second end 3.8. Generally the segment that attaches at the base is considered the first segment and each segment attached thereto is the next segment in the order of segments. As shown in FIG. 2, segment 2.4 is the first segment and segment 2.1 is the second segment. As shown in FIG. 3 segment 3.7 is the first segment, segment 3.4 is the second segment and segment 3.1 is the third segment. As shown in FIG. 5, segment 5.20 is the first segment, segment 5.4 is the second segment, and segment 5.1 is the third segment. Preferably segments are of equal shapes and sizes according to the order of segment, thus, as shown in FIG. 6, first segments, 6.15, 6.18, and 6.21, second segments 6.14, 6.17, and 6.20, and third segments 6.13, 6.16, and 6.19, are of equal shape and size.

Where two segments of a leg meet is referred to as a joint. As shown in FIG. 2 a joint 2.16 is formed where first end 2.3 of segment 2.1 joins second end 2.5 of segment 2.4. As shown in FIG. 3 a joint 3.19 is formed where first end 3.3 of segment 3.1 joins second end 3.5 of segment 3.4, and joint 3.20 is formed where first end 3.6 of segment 3.4 joins second end 3.8 of segment 3.7. As shown in FIG. 5, joint 5.23 is formed where first end 5.22 of segment 5.20 joins second end 5.5 of segment 5.4, and joint 5.24 is formed where first end 5.6 of segment 5.4 joins second end 5.5 of segment 5.1. The segments may join to each other at their ends by joining devices including a clamp ring. The joining device such as a clamp ring may be part of the segments, welded to the segments, or attached to the segments. The clamp rings may have holes through which bolts or nuts or other fastening devices may be inserted to join together the segments.

The angle of a joint at which segments are joined, as shown in particular instances in FIG. 2, 2.17, FIG. 3, 3.21 and 3.22, FIG. 5, 5.26 and 5.27, will be determined according to varying conditions including the area restrictions, the circumstances, condition or state of the monopole, including height, composition, construction and weight of the monopole, and the load to be redistributed. Leg segmentation, which is the formation of a leg by at least two segments with a joint, facilitates and maximizes distribution of loads onto legs. Leg segmentation and height variation or a combination thereof facilitates meeting space and area limitations in the monopole environment.

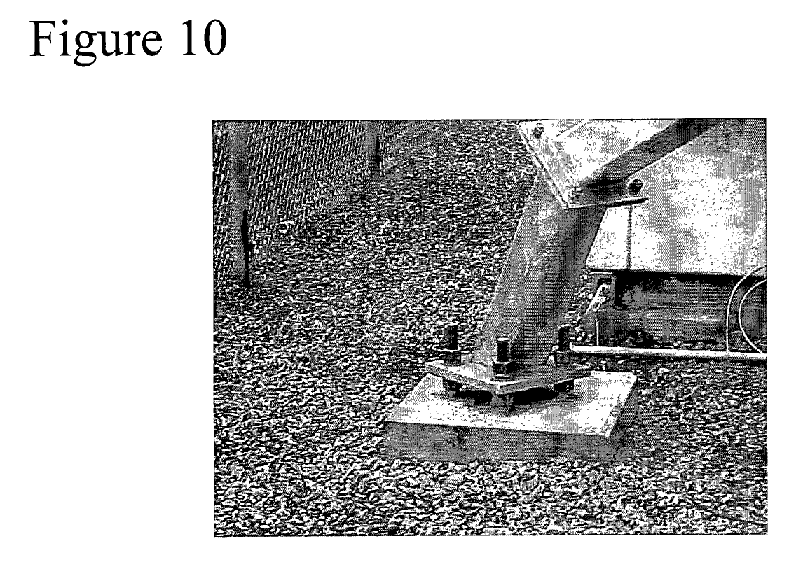

Bases, as shown in FIG. 2, 2.14, FIG. 3, 3.18, FIG. 5, 5.19, FIG. 6, 6.4, 6.7, and 6.10, and FIG. 10, function to support legs of a load distribution mechanism. A base is composed of a base plate, as shown in particular instances in FIG. 5, 5.7 and FIG. 10, which is attached to a foundation, as shown in particular instances in FIG. 5, 5.8 and FIG. 10.

In a preferred embodiment, a base plate is equipped with holes through which bolts or other fasteners can be inserted to attach the base plate to a foundation. Preferably, a base plate may attach to, be welded to, or be an extension of the lower end of a leg.

Foundations are constructed for each leg of the load distribution mechanism. Foundations may be selected from the group consisting of concrete, steel, tar, dirt or combinations thereof. In contrast to other support systems, the foundations for the present invention do not need to be as large as tension-based systems because the present invention uses predominantly compression-resistance type support, rather than tensile-based support. In this manner, the foundations resist the transverse moment of the monopole. Thus, the foundation for the present invention requires less excavation and less soil compression or resistance than prior art systems. These characteristics of the present invention allow for more rapid installation than prior art systems.

As shown in FIG. 4, 4.9, and FIG. 5, 5.16, a base for each leg of the load distribution mechanism is placed at a variable radial distance from the center of the monopole. Each base is distanced from the monopole according to varying conditions including the area restrictions, the circumstances, condition or state of the monopole, including height, composition, construction and weight of the monopole, and the load to be redistributed. As shown in FIG. 6 and FIG. 7, preferably the bases are spaced equidistant from the monopole center. In a preferred embodiment, new caissons are drilled around an existing monopole foundation at specific distances.

The actual parameters of the different parts of the load redistribution mechanism may be modeled using mathematical algorithms or computer programs. Such algorithms or programs will model the load redistribution mechanism of any number of legs, model each leg as a composition of one, two or three segments, calculate vector forces and reactions at the bases, calculate the internal forces at all joints of each leg, model analyze and view several scenarios and combinations of new additions to the monopole or load redistribution mechanism, contain ready-made tables of leg structural components, determine the elevation of connectivity joint to monopole, the arrangement of the legs, the radial distance from monopole center, and the structural properties of the legs.

The load distribution mechanism described above is performed by evaluating the existing state of a new or old monopole to determine the parameters and requirements of the load distribution mechanism, this includes the number of legs required, the number of segments required for each leg, the distance the lower end of the leg must be from the monopole center, the height at which the upper end of the leg is attached to the monopole, and installing the load distribution mechanism. Installing the load distribution mechanism requires creating a foundation at a calculated distance from the center of the monopole for each lower end of each leg of the load distribution mechanism to create a base for each leg. Preferably, the spacing of the legs will be at equal angles and attachment of the legs to the monopole will preferably be at equal heights.

Thus, the present invention provides a compact load distribution mechanism that provides full-time support, maximizes load transfer of monopole moment for a given base area, and is easy to install.

Certain modifications and improvements will occur to those skilled in the art upon a reading of the foregoing description. By way of example, bent leg structures can be used instead of jointed leg structures. All modifications and improvements have been deleted herein for the sake of conciseness and readability but are properly within the scope of the following claims.

I claim:

1. A load redistribution device for monopoles, comprising:
a plurality of legs, each leg having an upper and lower end and at least one joint, the upper end attachably joined at a load-bearing height to a monopole and the lower end attachably joined to a base at a variable radial distance from a center of the monopole.

2. The device according to claim 1, wherein the upper end is substantially perpendicular to the long axis of the monopole.

3. The device according to claim 1, wherein the plurality of legs is spaced equally.

4. The device according to claim 3, wherein each base is equidistant from the center of the monopole.

5. The device according to claim 1, wherein the legs comprise a plurality of segments each segment with first and second ends.

6. The device according to claim 5, wherein the segments are selected from the group consisting of steel rods, tubular structures and combinations thereof.

7. The device according to claim 5, wherein the plurality of segments is one segment, said one segment with first end of said one segment attachably joined to a base and second end of said one segment attachably joined to a monopole.

8. The device according to claim 5, wherein the plurality of segments is two segments,
first end of first segment attachably joined to a base and second end of first segment attachably joined to second segment,
first end of said second segment attachably joined to second end of first segment, and second end of said second segment attachably joined to a monopole.

9. The device according to claim 5, wherein the plurality of segments is three segments,
first end of first segment attachably joined to a base and second end of said first segment attachably joined to second segment,
first end of said second segment attachably joined to second end of said first segment, and second end of said second segment attachably joined to third segment,
first end of said third segment attachably joined with second end of said second segment, and second end of said third segment attachably joined to monopole.

10. A load-supporting device for monopoles, comprising:
three or more legs, each leg spaced at equal angles form each other, each leg having an upper and lower end, the upper end attachably joined at a load-bearing attachment height to a monopole and the lower end attachably joined to a base at an equal radial distance from the center of the monopole, said attachment height being equal for each leg, and said upper end being angled substantially perpendicular to the long axis of the monopole.

11. The device according to claim 10, wherein the legs further include at least one joint.

12. The method of creating a load redistribution device comprising the steps of:
a) determining the parameters and requirements of the load redistribution mechanism including determining the number of legs required, the number of segments per leg required, the distance of the lower ends of the legs from the monopole center, the height at which the legs must be attached to the monopole and the angle of each joint
b) creating a foundation for the lower end of each leg required at a determined distance from the monopole center
c) assembling each leg of the load redistribution mechanism, including joining a determined number of segments per leg,
d) attaching lower end of each leg of the number of determined legs to the foundation and
e) attaching upper end of each leg to the monopole at a determined height.

13. The method according to claim 12, wherein concrete is used to created the foundation.

14. The method according to claim 12, wherein the lower end of each leg is attached by inserting bolts through a base plate at the lower end of the of the leg which bolts connect the foundation to the base plate thereby forming the base.

15. The method according to claim 12, wherein the upper end of each leg is attached using bolts to upper and lower face plates attached to the monopole.
